(19) United States
(12) Patent Application Publication
(10) Pub. No.: US 2010/0106666 A1
(43) Pub. Date: Apr. 29, 2010

(54) EASILY REMOVABLE ADVERTISING MEDIUM FOR AUTOMOBILES

(76) Inventor: Cecilia Zachmann, Weinfelden (CH)

Correspondence Address: DORITY & MANNING, P.A., POST OFFICE BOX 1449, GREENVILLE, SC, 29602-1449, US

(21) Appl. No.: 12/447,747

(22) PCT Filed: Nov. 26, 2007
(86) PCT No.: PCT/CH2007/000590

§ 371 Date: Apr. 29, 2009

(30) Foreign Application Priority Data
Dec. 8, 2006 (CH) 2002/06

(51) Int. Cl. G09F 21/04; G06Q 90/00

(52) U.S. Cl. 705/500

(57) ABSTRACT

An advertising medium, which comprises a cover and fits over the exterior of a rear-view mirror of a motor vehicle. The advertising medium is easily pulled on and secured to the rear-view mirror housing of the vehicle. An advertising logo can be placed on the outward facing side of the advertising medium for view by those approaching the vehicle.

### PRIORITY CLAIM

The present application claims priority to International Application Number PCT/CH2007/000590 filed on Nov. 26, 2007 which claims priority to Swiss Application Number CH 2002/06 filed on Dec. 8, 2006.

### FIELD OF THE INVENTION

The subject matter of the invention is an advertising medium for motor vehicles which can be affixed to and easily removed from motor vehicles without damaging the vehicle and leaving minimal, if any, traces that the advertising medium had been attached to the vehicle.

### BACKGROUND

It is known to apply an advertising medium on motor vehicles. This has previously been effected using one-sided transparent films for windows as well as placement on side doors or the hatch door. The production and application of such advertisements is time-consuming and also expensive and is found primarily for use with permanent advertisements. Advertisement for certain one-time occasions is therefore not possible.

### SUMMARY

One embodiment of this invention comprises an advertising medium which can be easily applied to and removed from motor vehicles without damaging the vehicle and leaving only traces of an attachment on the motor vehicle.

In one embodiment of the invention, this is accomplished through the application of an elastic textile surface material on which the advertisement is applied, e.g. printed or embroidered. The advertising medium includes a cover comprised of expandable material, which is pulled over the exterior rear-view mirrors and thereby attached via suitable means known to those skilled in the art. In a particularly advantageous embodiment of the invention, elastic retaining instruments are integrated directly in the advertising medium, so that the advertising medium can be attached on exterior rear-view mirrors without the need for further attaching mechanisms or devices. In this manner, for example, advertisements for a sporting event such as logos, data or texts, can be displayed before and during the event on the motor vehicles to which the advertising medium is applied. After expiration of the event the advertising medium can easily be removed. The advertising medium can very inexpensively be produced, so that, for example, the organizer of the event can supply the advertising material for free or for a small amount, e.g. a sponsorship fee.

### BRIEF DESCRIPTION OF THE DRAWINGS

FIG. 1 a partial portrayal of a motor vehicle in perspective view,

FIG. 2 an enlarged portrayal of the advertising medium and

FIG. 3 a view of the exterior rear-view mirror of a motor vehicle with a pulled over advertising medium.

### DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

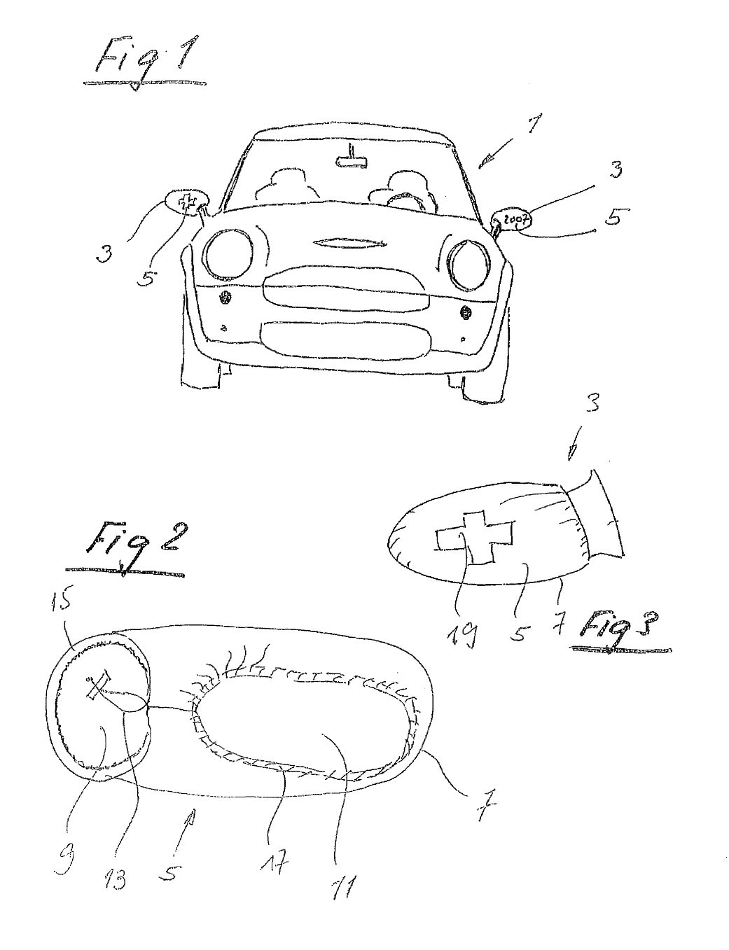

In FIG. 1 shows a schematic of a passenger car portrayed on which both exterior rear-view mirrors 3 are visible. This embodiment is not limited to just a passenger car and can of course instead be a truck or also a two wheeler stand. Advertising medium 5 is shown mounted on both exterior rear-view mirrors. The advertising medium 5 is applied in such a manner on the exterior rear-view mirrors 3, that an advertisement, here represented by a Swiss cross, is visible when approaching the vehicle from the front.

The advertising medium 5 comprises manufactured cover 7 which can comprise an elastic material, such as for example elastic material employed for ski suits or cycling apparel as known to one skilled in the art. Manufactured cover 7 has two openings 9 and 11. The first opening 11 is located on the rear side, i.e. the side where the mirror is locate and encompasses the frame of the exterior rear-view mirror 3 in such a way that the mirror is not covered and the mirror therefore retains full function. The second opening 9 serves to allow the advertising medium 5 to be pulled onto and off of the mirror exterior by the cover 7 pulling over the exterior 3. The advertising medium 5 attaches and connects to the vehicle between exterior rear-view mirror 3 and the body of the motor vehicle 1 with help of a string 13 or other suitable means known in the art. In another embodiment, an alternative to a string is an elastic band disposed in a seam 15. There is also seam 17, which defines and surrounds the first opening 11, which has an elastic band inserted, so that the cover 7 is closely held on the exterior rear-view mirror body. Keeping the advertising medium 5 close to the rear-view mirror body prevents fluttering sounds and premature destruction by fluttering at high speeds.

For larger motor vehicles such as trucks and cars, cover 7 is larger and has larger openings 9 and 11 to accommodate the respective attachment arms of the larger motor vehicle.

1. Advertising medium for motor vehicles, comprehensive a material structure on which advertisement applied and for the potential customer is visible, characterized by an of elastic expandable material existing cover, on which the advertisement is applied is and which in such a manner is dimensioned, that he on an exterior rear-view mirror of the motor vehicle pulled over and on this from front visible is kept.

2. Advertising medium according to claim 1, thereby characterized, that as advertisement logos, data or text on the advertising medium are applied.

3. Advertising medium according to claim 1, thereby characterized, that on the cover at least one opening for pulling over of the advertising medium over the exterior rear-view mirror is applied.

4. Advertising medium according to claim 1, thereby characterized, that on the cover an opening for the face of the mirror is applied.

5. Advertising medium according to claim 3, thereby characterized, that around the openings an elastic band is inserted.

6. Advertising medium according to claim 3, thereby characterized, that around the opening a string for the pulling together of the opening is applied.

7. An advertising medium for use on an exterior rear view mirror, having a
reflection surface and received by a support mount on a motor vehicle, comprising;
a one-piece outer cover;
an inner surface disposed on the underside of the outer cover;
a first seam located in the outer cover;
wherein the first seam forms a continuous boundary and defines a first opening;
wherein the first seam engages a perimeter of an external rear view;
wherein the first seam and outer cover do not extend onto the reflective surface of the external rear view mirror;
a second seam located in the outer cover;
wherein the second seam forms a second continuous boundary and defines a second opening;
wherein the second seam engages a support mount for the external rear view mirror;
wherein the first and second openings defined by the first and second seams do not meet and are separated by a continuous portion of the outer cover; and
an advertisement on the outer cover facing away from the external rear view mirror.

8. An advertising medium as claimed in claim 7 wherein;
a string is disposed within the second seam; and
wherein the string may be adjusted to vary the size of the second opening.

9. An advertising medium as claimed in claim 7 wherein there is an elastic member disposed within the first and second seams.

10. An advertising medium as claimed in claim 7 wherein the cover comprises an elastomeric material.

11. An advertising medium as claimed in claim 10, wherein the elastomeric material causes the inner surface to engage with an outer surface of the exterior rear view mirror substantially along the entirety of the inner surface.

12. An advertising medium as claimed in claim 7 wherein the advertisement may comprise logos, data, text or combinations of the above.

13. An advertising medium as claimed in claim 7 wherein the first opening is substantially rectangular in shape.

14. An advertising medium as claimed in claim 7 wherein the second opening is substantially circular in shape.

15. An advertising medium as claimed in claim 7 wherein the continuous portion of the outer cover separating the first and second openings contains a substantially horizontal seam.

16. An advertising medium for use on the exterior rear view mirrors of motor vehicles, comprising;
a one-piece outer cover comprised of an elastomeric material;
an inner surface disposed on the underside of the outer cover;
a first seam located in the outer cover;
wherein the first seam forms a continuous boundary and defines a first opening;
wherein the first seam engages a perimeter of a support for an external rear view mirror which has a reflective surface;
wherein the first seam and outer cover do not extend onto the reflective surface of the external rear view mirror;
a second seam located in the outer cover;
wherein the second seam forms a second continuous boundary and defines a second opening;
wherein the second seam engages a support mount for the external rear view mirror;
wherein the first and second openings defined by the first and second seams are separated by a continuous portion of the outer cover;
an advertisement on the outer cover facing away from the external rear view mirror; and
an elastic member disposed with the first and second seams.
